(19) United States
(12) Patent Application Publication
(10) Pub. No.: US 2008/0048400 A1
(43) Pub. Date: Feb. 28, 2008

(54) UNITIZED SEAL WITH INTEGRAL FLANGED SLEEVE

(75) Inventor: John C. Dahlheimer, Laconia, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/467,582

(22) Filed: Aug. 28, 2006

(51) Int. Cl. F16J 15/38

(52) U.S. Cl. 277/391

(57) ABSTRACT

A mechanical face seal includes an elastomeric boot including a bellows portion extending radially from a tube portion. The tube portion includes a flanged end having a tapered surface on a leading end and a flat surface on a trailing end. A spring is disposed around the tube portion and has a first end disposed against the boot. A seal washer is disposed around the tube portion and engages a second end of the spring. The seal washer includes a radially outwardly extending portion that engages the bellows portion. A seal seat is disposed around the tube portion and has a face surface that is engaged by the seal washer. The seal seat is supported by a grommet having a retention lip for engaging the tube portion.

### FIELD

The present disclosure relates to a mechanical face seal, and more particularly to a mechanical face seal having a boot with an integrated bellows portion and axially extending tube portion that provides a reduction of components and easier assembly.

### BACKGROUND AND SUMMARY

The statements in this section merely provide background information related to the present disclosure and may not constitute prior art.

Water pumps with impellers are used in appliances, such as dishwashers and washing machines, to move liquid through and out of the appliance in a series of wash, rinse, and drain cycles. Typically, the pump includes a housing, a rigid cover, and an impeller for mounting onto a rotatable drive shaft or motor shaft. A separate mechanical face seal assembly consisting of a seal head assembly and a seal seat for preventing liquid leakage between the fixed housing and the rotating impeller is used. The existing face seal design uses a hard plastic sleeve and spring seat that snap together to unitize the seal and a rubber washer to prevent the seal ring from rattling against the hard plastic sleeve.

The mechanical face seal of the present disclosure eliminates the need for the hard plastic sleeve, spring seat, and rubber washer. The present disclosure provides a face seal including an elastomeric boot including a bellows portion extending radially from a tube portion. The tube portion includes a flanged end having a tapered surface on a leading end and a generally flat surface on a trailing end. A spring is disposed around the tube portion and has a first end disposed against the boot. A seal washer is disposed around the tube portion and engages a second end of the spring. The seal washer includes a radially outwardly extending portion that engages the bellows portion. A seal seat is disposed around the tube portion and has a face surface engaged by the seal washer. According to an aspect of the present disclosure, the seal seat is supported by a grommet which surrounds the tube portion. The grommet has an inner diameter smaller than an outer diameter of the flanged end of the tube portion. During assembly of the face seal, the tube portion of the boot passes freely through the spring, seal washer, and seal seat and then is pressed through an elastomeric retention lip provided on the interior of the grommet which is assembled around the seal seat. Once the tube flange passes through the retention lip, the retention lip contracts back to its original size, the inside diameter which is smaller than the outside diameter of the tube flange. The grommet retention lip serves to lock the seal together in a unitized seal assembly which resists disassembly during normal transportation, handling and installation into a pump.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a partial cross-sectional view of an exemplary mechanical face seal in accordance with the principles of the present disclosure;

FIG. 2 is a cross-sectional view of the boot and case utilized in accordance with the principles of the present disclosure;

FIG. 3 is a cross-sectional view of the seal washer in accordance with the principles of the present disclosure;

FIG. 4 is a perspective view of the ferrule utilized in accordance with the principles of the present disclosure; and

FIG. 5 is a cross-sectional view of a grommet utilized in accordance with the principles of the present disclosure;

### DETAILED DESCRIPTION

The following description is merely exemplary in nature and is not intended to limit the present disclosure, application, or uses. It should be understood that throughout the drawings, corresponding reference numerals indicate like or corresponding parts and features.

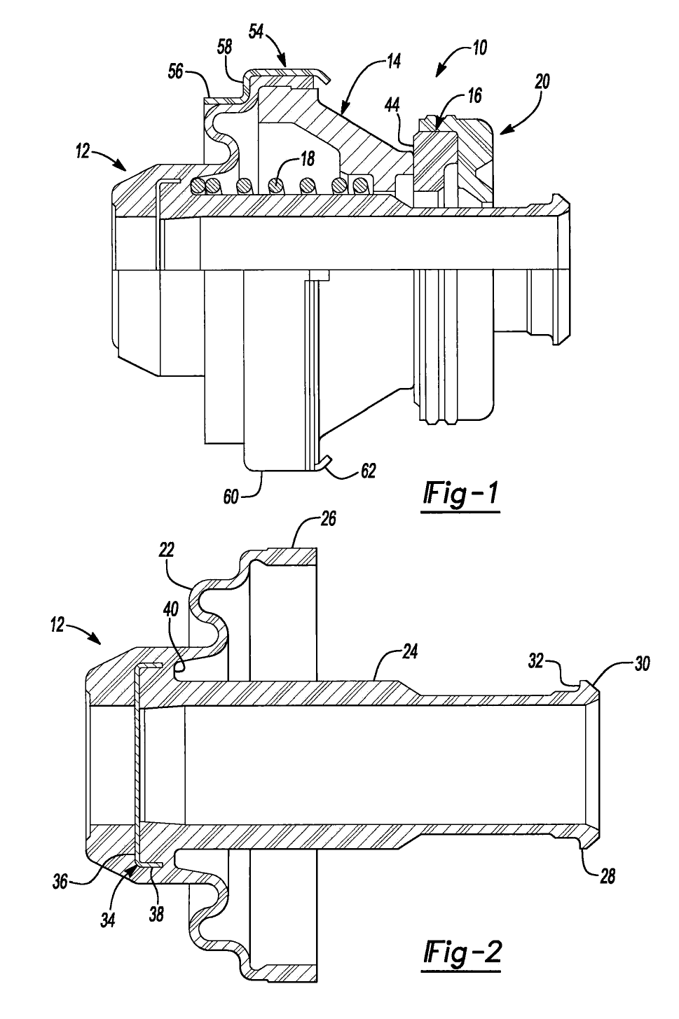

With reference to FIG. 1, a mechanical face seal 10 is shown including an elastomeric boot 12 that is sealingly engaged with a seal washer 14. The seal washer 14 is biased against a seal seat 16 by a spring 18. The seal seat 16 is supported by a grommet 20.

With reference to FIGS. 1 and 2, the boot 12 includes a bellows portion 22 and a tube portion 24 integrally formed with the bellows portion 22, as a unitary one-piece member. The bellows portion 22 extends radially outwardly from the tube portion 24 and includes an axially extending engagement region 26 which is adapted to sealingly engage seal washer 14. Tube portion 24 is provided with a flanged end 28. The flanged end 28 of the tube portion 24 has a tapered surface 30 on its leading end and a flat surface 32 on its trailing end.

A reinforcement case 34 is provided in the boot 12 and includes a radially extending portion 36 terminating in an axially extending outer flange 38. The boot 12 includes a spring seat portion 40 disposed between bellows portion 22 and tube portion 24, that defines an annular recess having a diameter approximately equal to the case 34. The boot 12 is preferably made of an elastomeric material such as rubber or other known elastomeric material. The case 34 is preferably made of metal or plastic and is designed to be generally rigid so as to reinforce the elastomeric material of the boot 12 so as to withstand the forces applied thereto by spring 18.

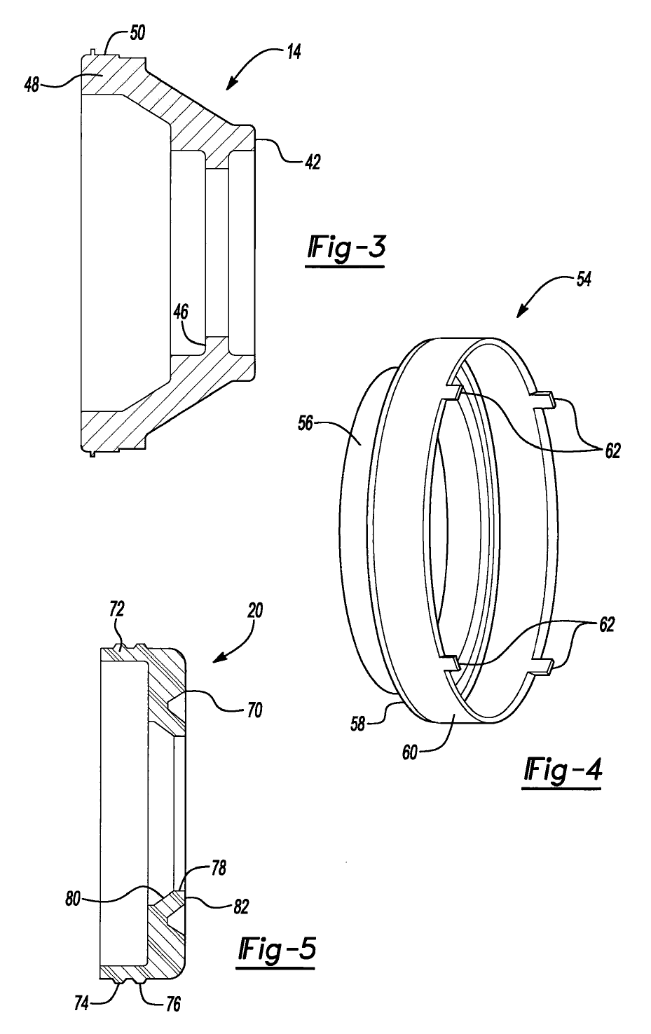

With reference to FIGS. 1 and 3, the seal washer 14 includes a face surface 42 which is designed to slide against an opposing face surface 44 of seal seat 16. The seal washer 14 defines a recessed spring seat portion 46 for receiving a second end of spring 18 thereagainst. The seal washer 14 also includes a radially outwardly extending portion 48 that is received within the engagement region 26 of bellows portion 22 of boot 12. The radially outwardly extending portion 48 of seal washer 14 can be provided with stepped shoulder portion 50 which facilitates engagement with the bellows portion 22 of boot 12.

With reference to FIGS. 1 and 4, a ferrule 54 is provided for surrounding the engagement region 26 of bellows 22 and seal washer 14. In particular, ferrule 54 includes an inner ring portion 56 and stepped shoulder portion 58 which is disposed against the bellows portion 22. An outer ring portion 60 extends axially from the shoulder portion 58 and surrounds the engagement region 26 of bellows 22 in order to clamp the engagement region 26 to the outer surface of seal washer 14. As shown in FIG. 1, the ferrule 54 includes axially extending fingers 60 which are crimped radially inward to secure the ferrule 54 in place.

With reference to FIGS. 1 and 5, the grommet 20 includes a radially inwardly extending portion 70 and an axially extending portion 72 inside of which the seal seat 16 is received. The axially extending portion 72 includes a pair of sealing beads 74, 76 radially extending therefrom. The radially inwardly extending portion 70 includes a retention lip 78 that has an inner diameter smaller than an outer diameter of the flanged end 28 of the tube portion 24 of boot 12. The retention lip 78 includes a tapered end 80 that is designed to engage the tapered end 30 of the flanged end 28 of tube portion 24 to facilitate the insertion of the flanged end 28 of tube portion 24 through the grommet 20 during assembly. The retention lip 78 also includes a flat face 82 opposite the tapered end 80 that is designed to engage the flat end 32 of flanged end 28 of tube portion 24 and thereby prevent the grommet 20 from being inadvertently removed from the tube portion 24 of boot 12.

The mechanical face seal of the present disclosure requires fewer components than conventional face seals and provides easier assembly and reduced costs as well. The grommet 20 is made of an elastomeric material and is easily expanded due to the corresponding tapered surfaces on both the lead end of the tube flange and the inside of the grommet retention lip 78. Once the tube flange 28 passes through the grommet 20, the retention lip 78 contracts back to its original size with the inside diameter being smaller than the outside diameter of the tube flange 28. The flat surface 82 on the retention lip 78 of the grommet 20 then serves to lock the seal together into a unitized seal assembly which resists disassembly during normal transportation, handling, and installation into a pump. The retention lip 78 is angled such that when attempting to retract the flanged end 28 of the tube portion 24 back through the retention lip 78 of the grommet 20, the flat trailing surface 32 of the flange 28 catches on the flat 82 terminating end of the retention lip 78. Increasing the retraction force in an attempt to pull the flange 28 back through the lip only causes the lip 78 to pivot radially inwardly and effectively contract radially inward ever tighter around the tube shoulder adjacent the retention flange. The elastomeric tube portion 24 prevents rattling noise from occurring when the seal seat 16 contacts the tube 24.

What is claimed is:

1. A face seal, comprising:
an elastomeric boot including a bellows portion extending radially from a tube portion, said tube portion including a flanged end having a tapered surface on a leading end and a generally flat surface on a trailing end;
a spring disposed around said tube portion and having a first end disposed against said boot;
a seal washer disposed around said tube portion and engaging a second end of said spring, said seal washer including a radially outwardly extending portion that engages said bellows portion;
a seal seat disposed around said tube portion end having a face surface engaged by said seal washer.

2. The face seal according to claim 1, wherein said tube portion is formed integrally as a one-piece member with said bellows portion.

3. The face seal according to claim 1, further comprising a case disposed within said boot.

4. The face seal according to claim 3, wherein said case extends radially inward from said tube portion.

5. The face seal according to claim 3, wherein said case has an outer diameter at least as large as an inner diameter of said spring.

6. The face seal acceding to claim 3, wherein said case includes a radially extending portion and an axially extending flange portion extending from an outer end of said radially extending portion and toward said spring.

7. The face seal according to claim 1, further comprising a ferrule surrounding an outer end of said bellows portion and said radially outwardly extending portion of said seal washer.

8. The face seal according to claim 7, wherein said ferrule includes a plurality of radially inwardly bent fingers for securing said ferrule in place.

9. The face seal according to claim 1, further comprising a grommet surrounding said tube portion and supporting said seal seat.

10. The face seal according to claim 9, wherein said grommet has an inner diameter smaller than an outer diameter of said flanged end of said tube portion.

11. The face seal according to claim 9, wherein an inner surface of said grommet includes a tapered end.

12. The face seal according to claim 9, wherein an outer surface of said grommet includes at least one sealing bead.

13. The face seal according to claim 9, wherein said grommet surrounds a section of said tube portion having a smaller diameter than an inner diameter of said grommet, thereby defining a gap therebetween.

14. The face seal according to claim 1, wherein said seal washer includes a recessed seat portion for receiving said spring.

15. The face seal according to claim 9, wherein said grommet includes an angularly disposed retention lip.

16. The face seal according to claim 15, wherein said retention lip includes a tapered surface on one side thereof and a flat, radially extending surface on a second side thereof.
